(19) United States
(12) Patent Application Publication
(10) Pub. No.: US 2010/0231827 A1
(43) Pub. Date: Sep. 16, 2010

(54) LIQUID CRYSTAL DISPLAY APPARATUS AND ILLUMINATING APPARATUS THEREFOR

(75) Inventors: Toyomi YAMASHITA, Niiza-shi (JP); Kengo Kimura, Niiza-shi (JP); Hideki Nakamichi, Niiza-shi (JP); Masanori Hoshino, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/723,029

(22) Filed: Mar. 12, 2010

(30) Foreign Application Priority Data
Mar. 16, 2009 (JP) 2009-062529
Oct. 5, 2009 (JP) 2009-231113

(51) Int. Cl. G02F 1/13357

(52) U.S. Cl. 349/65

(57) ABSTRACT

An LCD apparatus includes an LCD panel to display an image and an LED backlight to illuminate the LCD panel from behind. The LCD panel has first sections divided in a vertical direction and second sections divided in a horizontal direction. The LED backlight includes an LED light source and an edge-type light guide. The LED light source includes LEDs that are arranged along at least one of upper and lower sides of the light guide and are allocated to the second sections, respectively. A brightness of an image displayed in a given second section is used to control a light quantity of the corresponding LED. Each LED radially emits light so that light beams from adjacent ones of the LEDs intersect each other.

### BACKGROUND OF THE INVENTION

1. Field of the Invention

The present invention relates to a liquid crystal display (LCD) apparatus employing a light emitting diode (LED) backlight with a light guide, as well as to an illuminating apparatus for an LCD apparatus.

2. Description of the Related Art

A backlight illuminates a light modulator such as an LCD panel from behind. Among the backlights, an LED backlight is attracting attention. The LED backlight includes alight source to emit white light. To produce the white light, the light source employs white LEDs that emit white light, or red, green, and blue LEDs that emit red light, green light, and blue light that are mixed to provide white light, or short-wavelength LEDs such as blue LEDs and fluorescent material to produce white light in combination.

Among the LED backlights, an underneath-type LED backlight disclosed in, for example, Japanese Unexamined Patent Application Publication No. H10-186311 arranges a plurality of LEDs in a matrix behind an LCD panel, to two-dimensionally emit light and uniformly illuminate the LCD panel. Another type is an edge-type LED backlight that employs a light guide and a plurality of LEDs arranged along a side of the light guide, the light guide uniformly diffusing light from the LEDs and evenly illuminating an LCD panel.

### SUMMARY OF THE INVENTION

Compared with the underneath-type LED backlight, the edge-type LED backlight uses a smaller number of LEDs, and therefore, is manufacturable at lower cost. The edge-type LED backlight, however, uniformly illuminates the entire area of an LCD panel, and therefore, is unable to partly dim the LCD panel whereas the underneath-type LED backlight can do so.

The present invention provides an LCD apparatus employing an edge-type LED backlight, as well as an illuminating apparatus for an LCD apparatus, each capable of reducing power consumption and realizing high contrast.

According to an aspect of the present invention, the LCD apparatus includes an LCD panel configured to display an image, the LCD panel being defined in a first direction and a second direction orthogonal to the first direction and being divided in the second direction into first sections and in the first direction into second sections; and an LED backlight configured to illuminate the LCD panel from behind, the LED backlight including an edge-type light guide and an LED light source having a plurality of LEDs arranged along at least one of upper and lower sides of the light guide. Each of the LEDs emits light along an optical path extending in the second direction into the light guide. Each of the second sections is associated with at least one of the light paths and a brightness of an image displayed in the second section is used to control a light quantity of the corresponding LED.

According to another aspect of the present invention, the illuminating apparatus for illuminating an LCD panel of an LCD apparatus from behind includes an edge-type light guide corresponding to the LCD panel divided in a first direction into first sections and in a second direction orthogonal to the first direction into second sections; and an LED light source having a plurality of LEDs arranged along at least one of upper and lower sides of the light guide. Each of the LEDs emits light along an optical path extending in the first direction into the light guide. Each of the second sections being associated with at least one of the light paths and a brightness of an image displayed in the second section is used to control a light quantity of the corresponding LED. Each of the LEDs emits light that radially spreads so that the peripheries of light beams from adjacent ones of the LEDs intersect each other at an incidence position to the light guide.

The LCD apparatus and illuminating apparatus according to these aspects are capable of reducing power consumption and realizing high contrast.

### BRIEF DESCRIPTION OF THE DRAWINGS

FIG. 1 illustrates an LCD apparatus according to Embodiment 1 of the present invention;

FIGS. 2A and 2B illustrate operation of an LCD panel and LED backlight of the LCD apparatus according to Embodiment 1;

FIGS. 3A and 3B illustrate operation of an LCD panel and LED backlight of an LCD apparatus according to Embodiment 2;

FIGS. 4A and 4B illustrate operation of the LCD panel and LED backlight of the LCD apparatus according to Embodiment 2;

FIGS. 5A and 5B illustrate operation of the LCD panel and LED backlight of the LCD apparatus according to Embodiment 2;

FIGS. 6A and 6B illustrate operation of an LCD panel and LED backlight of an LCD apparatus according to Embodiment 3;

FIG. 7 partly illustrates an LCD apparatus according to Embodiment 4; and

FIGS. 8A and 8B partly illustrate an LCD apparatus according to Embodiment 5.

### DESCRIPTION OF THE PREFERRED EMBODIMENT

An LCD apparatus employing an LED backlight with a light guide, an illuminating apparatus for an LCD apparatus, and a method of controlling an LCD apparatus according to embodiments of the present invention will be explained in detail with reference to the drawings. Through the drawings, the same or similar parts are represented with the same or similar reference marks. The drawings only schematically illustrate the apparatuses and the components thereof and differ from actual products to be produced according to the present invention. Scaling factors are not always equal among the drawings.

### Embodiment 1

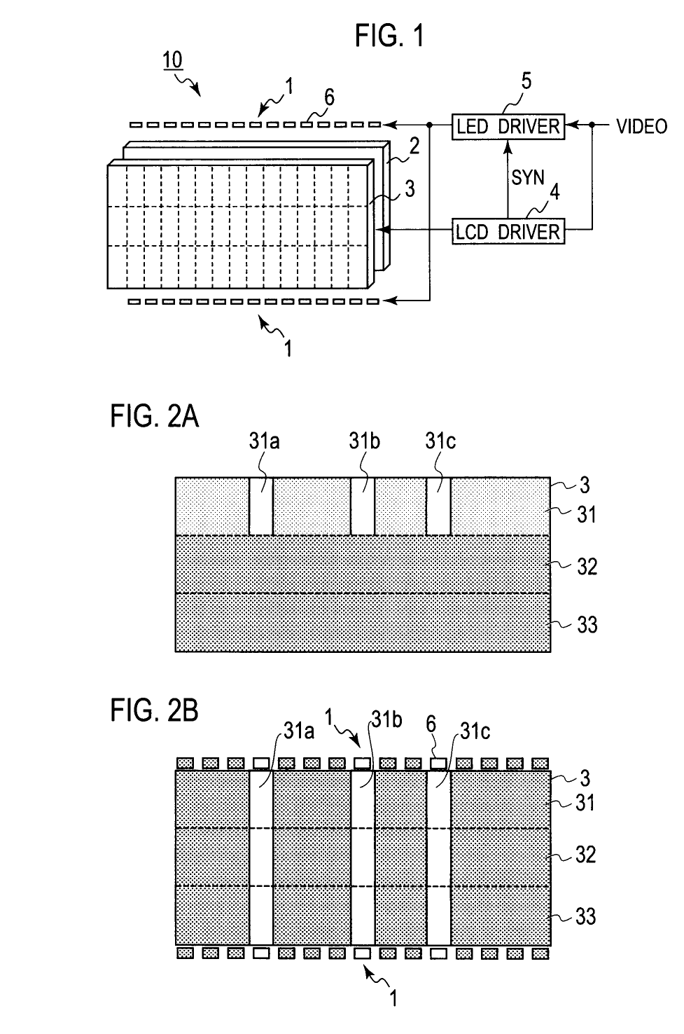

FIG. 1 illustrates an LCD apparatus employing an LCD panel and an edge-type LED backlight according to Embodiment 1 of the present invention and FIGS. 2A and 2B illustrate operation of the LCD panel and LED backlight of the LCD apparatus according to Embodiment 1.

A configuration of the LCD apparatus 10 according to the present embodiment will be explained with reference to FIG. 1. The LCD apparatus 10 has an LED light source 1, a light guide 2, the LCD panel 3, an LCD driver 4, and an LED driver 5. The LED light source 1, light guide 2, and LED driver 5 constitute the LED backlight of the present invention. The LCD panel 3 is defined in a horizontal direction (first direction) and a vertical direction (second direction) orthogonal to the horizontal direction.

The LED light source 1 includes a plurality of LEDs 6 each being directional and emitting white light. The LEDs 6 are linearly arranged along an upper side (top side) and a lower side (bottom side) of the light guide 2. The number of the LEDs arranged along the upper side of the light guide 2 is equal to the number of the LEDs arranged along the lower side thereof. The light guide 2 is made of, for example, an acrylic board. One light guide is arranged for one LCD panel. White light from the LED light source 1 enters a side face (light incidence surface) of the light guide 2, advances along an optical path straightly extending inside the light guide 2, and fully diffuses through the optical path to illuminate one face of the light guide 2.

The light guide 2 of the above-mentioned configuration is called an edge-type light guide. The LCD panel 3 is configured to change a light transmittance of liquid crystals by changing orientations of liquid crystal molecules in response to a control signal. The LCD panel 3 is arranged on a surface of the light guide 2 with a diffusing film (not illustrated) and an optical film (not illustrated) being arranged between the LCD panel 3 and the light guide 2.

For controlling the LCD panel 3, the LCD panel 3 is divided in the vertical direction into an upper first section 31, a center first section 32, and a lower first section 33. These sections 31, 32, and 33 are hereinafter referred to as “display sections” and correspond to the first sections stipulated in the claims. The LCD panel 3 is also divided in the horizontal direction into illumination sections that correspond to the second sections stipulated in the claims. The display sections 31, 32, and 33 are controlled to display images therein in time division in order of 31, 32, and 33.

In FIG. 1, the LCD panel 3 is divided in the horizontal direction into 15 illumination sections each involving at least one LED light path. Each LED light path is oriented in the vertical direction. According to the present embodiment, each side of each of the 15 illumination sections is provided with one LED 6. The LCD panel 3 may be divided into an optional number of illumination sections and an optional number of LEDs may be allocated for each illumination section.

The LCD driver 4 is connected to a video processor (not illustrated), the LCD panel 3, and the LED driver 5. The LED driver 5 is connected to the video processor, LCD driver 4, and LED light source 1.

With reference to FIGS. 2A and 2B, operation of the LCD apparatus 10 according to Embodiment 1 will be explained.

The LCD driver 4 receives R (red), G (green), and B (blue) video signals (VIDEO) from the video processor (not illustrated) and controls orientations of liquid crystals according to video signal intensities such as R, G, and B values and gray values, thereby displaying images on the LCD apparatus 10. At the same time, the LCD driver 4 provides the LED driver 5 with a synchronization signal (SYN) corresponding to a display section that is presently scanned. According to the video signals (VIDEO) and synchronization signal (SYN), the LED driver 5 synchronously controls the LED light source 1 arranged along the upper and lower sides of the light guide 2.

In FIG. 2A, the LCD driver 4 scans the upper display section 31 of the LCD panel 3. The LCD driver 4 outputs control signals according to video signals to the upper display section 31 and displays black in the center display section 32 and lower display section 33. At the same time, the LCD driver 4 outputs a synchronization signal corresponding to the upper display section 31 to the LED driver 5. In response to the synchronization signal, the LED driver 5 reads R, G, and B values from the video signals for the upper display section 31 and controls the LED light source 1 illumination section by illumination section according to a control amount calculated from the video signals. The control amount applied to the LED light source 1 may be determined according to an integration or average of R, G, and B values corresponding to a given illumination section. When bright images are displayed in the illumination sections 31a, 31b, and 31c in the upper display section 31 of the LCD panel 3, LEDs 6 corresponding to the illumination sections 31a, 31b, and 31c are controlled to be brighter and LEDs 6 corresponding to the other illumination sections are controlled to be dimmer or OFF as illustrated in FIG. 2B. Namely, any illumination section in which a bright image is displayed is illuminated bright and the other illumination sections are illuminated dark.

After displaying the upper display section 31, the LCD driver 4 displays the center display section 32 and then the lower display section 33. In this way, the LCD driver 4 sequentially scans the display sections 31, 32, and 33 in time division. At the same time, the LCD driver 4 provides the LED driver 5 with a synchronization signal corresponding to a now scanning display section. According to the synchronization signal and video signals for the illumination section, the LED driver 5 continuously controls the LED light source 1. The LEDs 6 of the LED light source 1 arranged along the upper and lower sides of the light guide 2 are synchronously controlled illumination section by illumination section. Accordingly, LEDs 6 on each side of a given illumination section are simultaneously turned on/off as illustrated in FIG. 2B. The LCD panel 3 of the LCD apparatus 10 according to Embodiment 1 repeats the above-mentioned operation.

As mentioned above, the LCD apparatus 10 according to the present embodiment divides the LCD panel 3 into the display sections and illumination sections and controls the LED light source 1 according to a brightness of an image displayed in each illumination section. Namely, a brightness of a given pixel of the LCD panel 3 is determined by a transmittance of the pixel, i.e., a liquid crystal orientation of the pixel and a brightness of LEDs 6 corresponding to the illumination section in which the pixel is present. This is effective to reduce power consumption and improve contrast and color shades.

The LCD apparatus 10 according to the present embodiment displays black in each display section that is not scanned. This suppresses blurs (ghosts) when switching images from one to another and improves the displaying quality of motion pictures.

The LCD apparatus 10 according to the present embodiment controls the LED light source 1 according to a synchronization signal corresponding to a display section and video signals indicating a brightness of an image displayed in the display section. LEDs 6 corresponding to illumination sections to display dark images are dimmed or turned OFT. This reduces power consumption of the LED light source 1.

If the LCD apparatus 10 is relatively small, or if each LED 6 is resistive to a large current to emit sufficiently bright light, the LED light source 1 may be arranged along only one of the upper and lower sides of the light guide 2. This reduces the cost of the LCD apparatus 10.

It is preferable to adjust a light quantity of each LED 6 by turning on/off the LED 6 with a constant current. This is simply achievable by making the LED driver 5 output a pulse drive signal. This reduces electric stress on each LED 6 and improves the reliability of the LED backlight.

### Embodiment 2

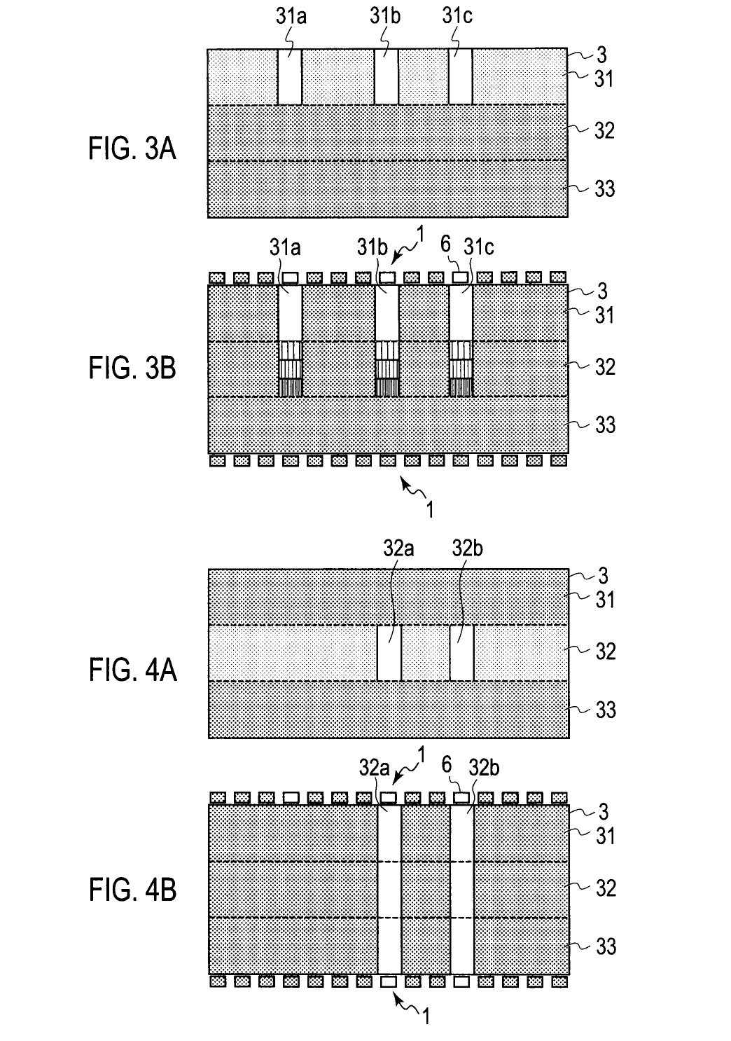

FIGS. 3A to 5B illustrate operation of an LCD panel and an LED backlight of an LCD apparatus according to Embodiment 2 of the present invention. The configuration of the LCD apparatus of Embodiment 2 is the same as that of Embodiment 1 illustrated in FIG. 1. Like Embodiment 1, Embodiment 2 divides an LCD panel 3 into an upper display section (upper first section) 31, a center display section (center first section) 32, and a lower display section (lower first section) 33 so that an LCD driver 4 sequentially scans the sections 31, 32, and 33 in this order.

The LED backlight according to the present embodiment has an LED light source 1 and an edge-type light guide 2 arranged under the LCD panel 3. The LED light source 1 includes LEDs 6 (the first LED light source stipulated in the claims) that are arranged along an upper side of the light guide 2, to emit light that passes along an optical path extending in a vertical direction and illuminates the upper display section 31 and center display section 32. The LED light source 1 also includes LEDs 6 (the second LED light source stipulated in the claims) that are arranged along a lower side of the light guide 2, to emit light that passes along an optical path extending in a vertical direction and illuminates the lower display section 33 and center display section 32. When all of the LEDs 6 on the upper and lower sides of the light guide 2 are simultaneously turned on, a brightness distribution over the light guide 2 becomes uniform.

When only the LEDs 6 of the LED light source 1 arranged along the upper side of the light guide 2 are turned on, the center display section 32 is illuminated dimmer than the upper display section 31. When only the LEDs 6 of the LED light source 1 arranged along the lower side of the light guide 2 are turned on, the center display section 32 is illuminated dimmer than the lower display section 33. The LCD driver 4 prepares control signals based on video signals, to scan the LCD panel 3 from the top toward the bottom thereof line by line (horizontal scanning). The LCD driver 4 provides an LED driver 5 with a synchronization signal corresponding to a presently scanned display section. According to the synchronization signal and video signals, the LED driver 5 separately controls the upper and lower LEDs 6 of the LED light source 1.

FIG. 3A illustrates that the LCD driver 4 scans the upper display section 31. The LCD driver 4 outputs control signals based on video signals for the upper display section 31, to display black in the center display section 32 and lower display section 33. At the same time, the LCD driver 4 provides the LED driver 5 with a synchronization signal corresponding to the upper display section 31. According to the synchronization signal, the LED driver 5 obtains brightness levels (R, G, and B values or gray values) from the video signals for the upper display section 31, and according to the brightness levels, controls the LED light source 1 to turn on/off the LEDs 6 illumination section by illumination section. The illumination sections are represented with 31a, 31b, 31c, . . . like Embodiment 1.

FIG. 3B illustrates that the illumination sections 31a, 31b, and 31c in the upper display section 31 of the LCD panel 3 display bright images with higher R, G, and B values. In this case, LEDs 6 corresponding to the illumination sections 31a, 31b, and 31c are controlled to be ON or brighter and LEDs 6 corresponding to the other illumination sections are controlled to be OFF or dimmer.

When the upper display section 31 is scanned line by line, only the LEDs 6 of the LED light source 1 arranged along the upper side of the light guide 2 is controlled according to the present embodiment. When the lower display section 33 is scanned line by line, only the LEDs 6 of the LED light source 1 arranged along the lower side of the light guide 2 is controlled.

FIG. 4A illustrates that the LCD driver 4 scans the center display section 32 line by line. The LCD driver 4 outputs control signals based on video signals to each line of the center display section 32 and displays black in every line of the upper and lower display sections 31 and 33. At the same time, the LCD driver 4 provides the LED driver 5 with a synchronization signal indicative of the center display section 32. In response to the synchronization signal, the LED driver 5 obtains brightness levels from the video signals for the center display section 32, and according to the brightness levels, controls the LED light source 1 to turn on/off the LEDs 6 illumination section by illumination section. When illumination sections 32a and 32b in the center display section 32 of the LCD panel 3 display bright images, LEDs 6 of the LED light source 1 corresponding to the illumination sections 32a and 32b on each side of the light guide 2 are controlled to be ON as illustrated in FIG. 4B.

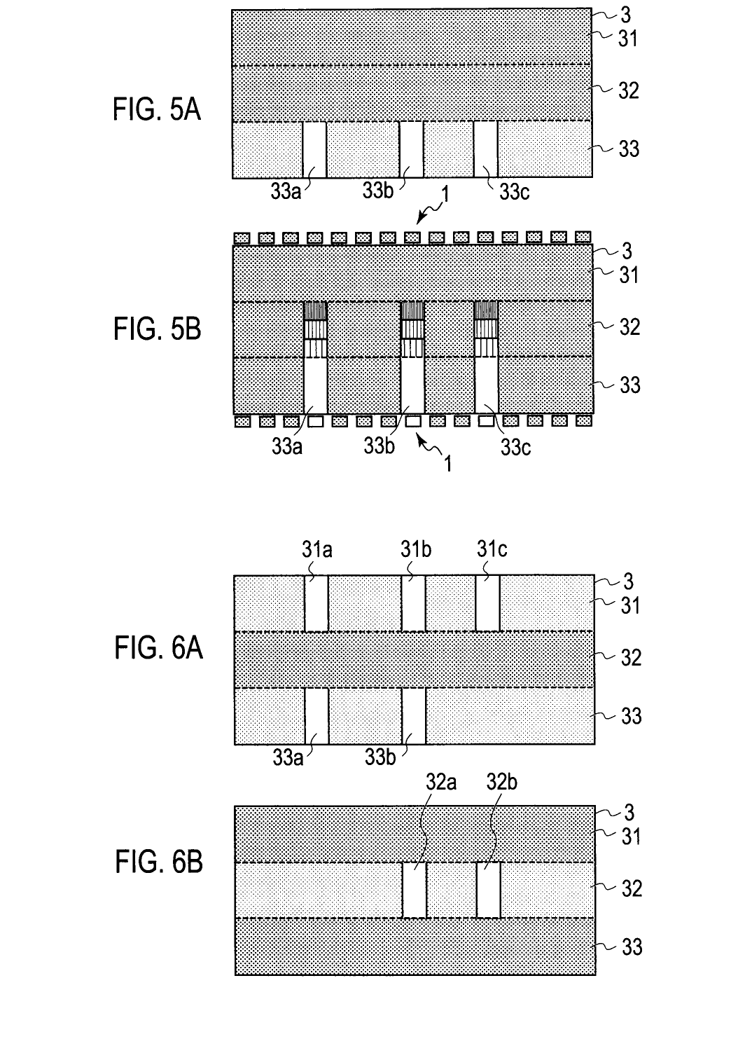

FIG. 5A illustrates that the LCD driver 4 scans the lower display section 33 line by line. The LCD driver 4 outputs control signals based on video signals to each line of the lower display section 33 and displays black in every line of the upper and center display sections 31 and 32. At the same time, the LCD driver 4 provides the LED driver 5 with a synchronization signal indicative of the lower display section 33. In response to the synchronization signal, the LED driver 5 obtains brightness levels from the video signals for the lower display section 33, and according to the brightness levels, controls the LED light source 1 to turn on/off the LEDs 6 illumination section by illumination section. FIG. 5B illustrates that illumination sections 33a, 33b, and 33c in the lower display section 33 of the LCD panel 3 display bright images, and therefore, only LEDs 6 of the LED light source 1 on the lower sides of the illumination sections 33a, 33b, and 33c are controlled to be ON.

The LCD apparatus 10 according to the present embodiment provides the same effect as Embodiment 1. In addition, the present embodiment separately controls the upper LEDs 6 and lower LEDs 6 of the LED light source 1 according to brightness levels of video signals applied to the display sections and illumination sections. This improves the contrast of images and the quality of motion pictures displayed on the LCD apparatus 10.

When displaying an image in only one of the upper and lower display sections 31 and 33, the LCD apparatus 10 of the present embodiment controls only the LEDs 6 of the LED light source 1 arranged along the corresponding side of the light guide 2. This is effective to further reduce power consumption.

According to Embodiment 2, each LED 6 is required to emit light up to a vertically intermediate part of the light guide 2, preferably to a vertically ⅔ part of the light guide 2. Accordingly, the LEDs 6 of Embodiment 2 may employ LED chips of relatively small current capacity. This reduces the costs of the LED light source 1 and LCD apparatus 10.

### Embodiment 3

FIGS. 6A and 6B illustrate operation of an LCD panel of an LCD apparatus according to Embodiment 3 of the present invention. The configuration of the LCD apparatus of Embodiment 3 is the same as that of Embodiment 1 illustrated in FIG. 1. Unlike Embodiments 1 and 2, Embodiment 3 simultaneously displays upper and lower display sections 31 and 33.

More precisely, the upper display section 31 and lower display section 33 of an LCD panel 3 simultaneously display images as illustrated in FIG. 6A. In the upper display section 31, illumination sections 31a, 31b, and 31c are bright, and in the lower display section 33, illumination sections 33a and 33b are bright. LEDs 6 are controlled according to brightness levels of the corresponding illumination sections.

After the upper and lower display sections 31 and 33 of the display panel 3, a center display section 32 is displayed as illustrated in FIG. 6B.

Embodiment 3 repeats the above-mentioned operation, to provide the same effects as Embodiments 1 and 2.

### Embodiment 4

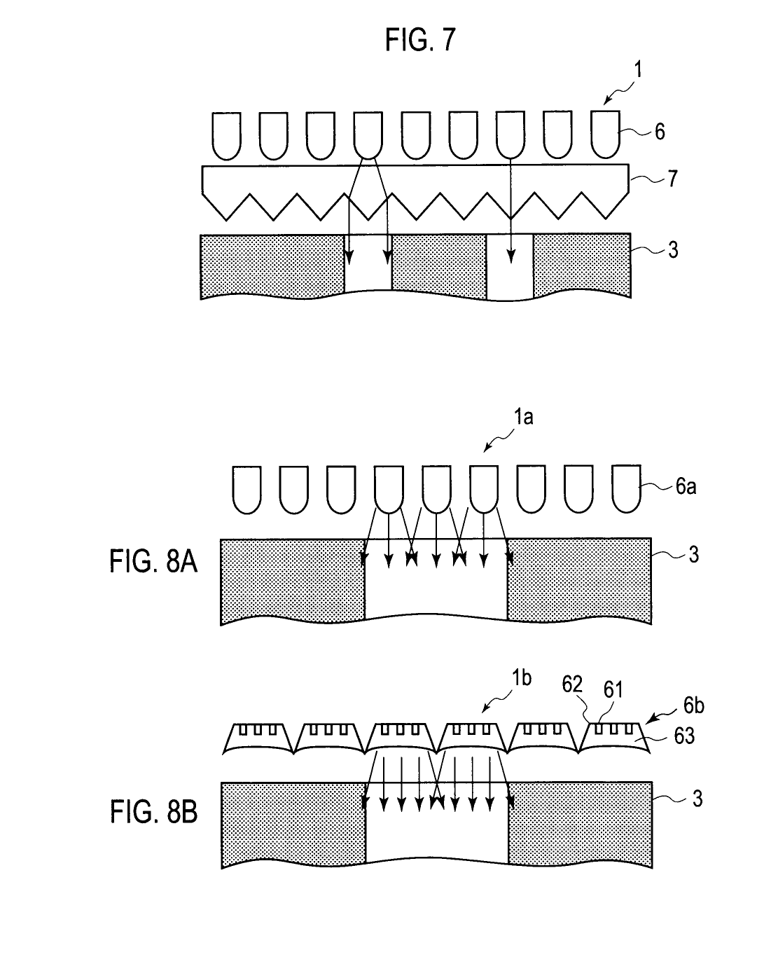

FIG. 7 partly illustrates an LCD apparatus according to Embodiment 4 of the present invention.

The LCD apparatus according to Embodiment 4 arranges a condensing lens 7 between an LED light source 1 and a light guide 2 arranged under an LCD panel 3. The condensing lens 7 has optical elements arranged for LEDs 6 of the LED light source 1, respectively. Each optical element of the condensing lens 7 condenses diffusing white light emitted from the corresponding LED 6 in one direction. According to the present embodiment, the condensing lens 7 condenses the white light into a parallel beam that is oriented orthogonal to a light incidence surface of the light guide 2.

Compared with the LCD apparatus of Embodiment 1, the LCD apparatus of Embodiment 4 can regulate the spreading white light emitted from the LEDs 6, to improve the contrast of images to display and the quality of motion pictures to display.

### Embodiment 5

FIGS. 8A and 8B partly illustrate an LCD apparatus according to Embodiment 5 of the present invention. Arrows in the drawings indicate directions of light emitted from LEDs 6.

The LED apparatus according to the present embodiment employs an LED light source 1 (1a, 1b) having LEDs 6a each being a wide directional element to radially emit light as illustrated in FIG. 8A, or LEDs 6b (linear light sources) each employing linearly arranged elements to emit a linear light beam whose optical path has a cross section elongated in an extending direction of a light guide 2 as illustrated in FIG. 8B. In FIGS. 8A and 8B, the light guide 2 is arranged under an LCD panel 3. Light beams from adjacent LEDs partly overlap each other to form no gap between them at the light guide 2. Namely, light from each LED spreads, and at a position to enter the light guide 2, the periphery of light from a given LED intersects the periphery of light from the adjacent LED, to form no gap between them.

In FIG. 8A, a plurality (three in FIG. 8A) of LEDs 6a are arranged for each illumination section defined on the light guide 2. The light guide 2 is constituted to improve the straightness of light and suppress the diffusion thereof. When the directivity of light from each LED 6a is high (narrow directivity), bright and dark spots will appear in a horizontal direction in each illumination section. To prevent this, the LEDs 6a must closely be arranged. When each LED 6a has wide directivity to radially emit light, the LEDs 6a may relatively sparsely be arranged. The sparse arrangement results in reducing the number of LEDs arranged in the LED light source 1, to reduce the cost of the LED backlight. The LED that radially emits light is disclosed in, for example, Japanese Unexamined Patent Application Publication No. 2003-282958.

To prevent the bright and dark spots mentioned above from appearing, the LED light source 1 may be constituted with a plurality of linear light elements as illustrated in FIG. 8B. In FIG. 8B, a plurality (two in FIG. 8B) of LEDs 6b are arranged for each illumination section defined on the light guide 2. Each LED 6b includes a plurality of LED chips in a single package. Namely, each LED 6b has a light reflector 62, a plurality (three in FIG. 8B) of LED chips 61 linearly arranged on the light reflector 62, and sealing resin 63 that contains fluorescent material and covers the LED chips 61. The LED 6b has an elongated light emitting face, to emit light that spreads along a cross section of the light guide 2.

Each LED 6b emits a linear light beam that is elongated in a direction in which the cross section of the light guide 2 extends. Accordingly, light beams from the LEDs 6b produce no gap at incidence positions to the light guide 2. This prevents bright and dark spots from appearing in a horizontal direction in each illumination section defined on the light guide 2. To radially spread light from the LED 6b, the light reflector 62 may have a tapered shape. The LED having a plurality of LED chips in a single package is disclosed in, for example, Japanese Unexamined Patent Application Publication No. 2004-296882.

According to Embodiment 5, it is preferable that light beams from adjacent ones of the LEDs 6a (6b) intersect each other between the LED light source 1 and the light guide 2.

Although the present invention has been described above by reference to certain embodiments of the present invention, the present invention is not limited to the embodiments described above. Modifications and variations of the embodiments described above will occur to those skilled in the art in light of the teachings. For example, the LCD panel 3 may be longer in the vertical direction than in the horizontal direction. The center display section 32 may be divided into two sub-sections. The number of the illumination sections may properly be changed. The synchronization signal may be any other signal or may be provided from any output unit.

This application claims benefit of priority under 35USC §119 to Japanese Patent Applications No. 2009-062529, filed on Mar. 16, 2009 and No. 2009-231113, filed on Oct. 5, 2009, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An LCD apparatus comprising:
an LCD panel configured to display an image, the LCD panel being defined in a first direction and a second direction orthogonal to the first direction and being divided in the second direction into first sections and in the first direction into second sections; and
an LED backlight configured to illuminate the LCD panel from behind, the LED backlight including an edge-type light guide and an LED light source having a plurality of LEDs arranged along at least one of upper and lower sides of the light guide, wherein
each of the LEDs emits light traveling along an optical path extending in the second direction into the light guide, and
each of the second sections is associated with at least one of the light paths and a brightness of an image displayed in the second section is used to control a light quantity of the corresponding LED.

2. The LCD apparatus of claim 1, wherein:
an image to be displayed on the LCD panel is displayed first section by first section in time division; and
the LED light source controls a light quantity of each LED according to the image to be displayed in time division.

3. The LCD apparatus of claim 1, wherein
the LED light source controls a light quantity of each LED by turning on and off the LED.

4. The LCD apparatus of claim 1, wherein
an image to be displayed on the LCD panel is displayed first section by first section in time division by scanning the LCD panel from the top toward the bottom thereof.

5. The LCD apparatus of claim 1, further comprising
a condensing lens being arranged between the LED light source and the light guide and configured to guide light emitted from the LED light source in a direction orthogonal to an incidence surface of the light guide.

6. The LCD apparatus of claim 1, wherein:
the LED light source includes a first LED light source arranged along the upper side of the light guide and a second LED light source arranged along the lower side of the light guide, the first and second LED light sources each having the same number of LEDs so that the LEDs of the first LED light source and those of the second LED light source oppose each other across the light guide;
the first sections include an upper first section, a lower first section, and one or two center first sections; and
the LED light source controls:
the first LED light source when an image is displayed in the upper first section,
the second LED light source when an image is displayed in the lower first section, and
the first and second LED light sources when an image is displayed in the center first sections.

7. The LCD apparatus of claim 1, wherein
light beams from adjacent ones of the LEDs intersect each other at a location between the LED light source and the light guide.

8. The LCD apparatus of claim 1, wherein
each of the LEDs has a light reflector and a plurality of LED chips linearly arranged on the light reflector.

9. An illuminating apparatus for illuminating an LCD panel of an LCD apparatus from behind, comprising:
an edge-type light guide corresponding to the LCD panel divided in a first direction into first sections and in a second direction orthogonal to the first direction into second sections; and
an LED light source having a plurality of LEDs arranged along at least one of upper and lower sides of the light guide,
each of the LEDs emitting light along an optical path extending in the first direction into the light guide, wherein
each of the second sections is associated with at least one of the light paths and a brightness of an image displayed in the second section is used to control a light quantity of the corresponding LED,
each of the LEDs emits light that radially spreads so that the peripheries of light beams from adjacent ones of the LEDs intersect each other at an incidence position to the light guide.
